(19) United States
(12) Patent Application Publication
(10) Pub. No.: US 2017/0117810 A1
(43) Pub. Date: Apr. 27, 2017

(54) ISOLATED AND EFFICIENT RECTIFIER SYSTEM

(71) Applicant: SCHNEIDER ELECTRIC IT CORPORATION, West Kingston, RI (US)

(72) Inventors: Rajesh Ghosh, Bangalore (IN); Mahendrakumar H. Lipare, Bangalore (IN); Damir Klikic, Waltham, MA (US); Mudiyula Srikanth, Bangalore (IN)

(21) Appl. No.: 15/129,516

(22) PCT Filed: Apr. 3, 2014
(86) PCT No.: PCT/US14/32758

§ 371 Date: Sep. 27, 2016

(51) Int. Cl. H02M 3/335; H02M 1/12; H02M 1/42

(52) U.S. Cl. CPC H02M 3/33507; H02M 1/4241; H02M 1/12

(57) ABSTRACT

According to at least one aspect, embodiments herein provide a method for providing regulated DC power to a load, the method comprising receiving input AC power, generating rectified AC power, the rectified AC power derived from the input AC power, converting the rectified AC power into regulated DC output power, and providing the regulated DC output power to an output coupled to the load.

### BACKGROUND OF INVENTION

1. Field of Invention

At least some embodiments described herein relate generally to Power Factor Correction (PFC) rectifiers.

2. Discussion of Related Art

Isolated AC-DC PFC rectifiers are commonly used in a variety of applications to convert supplied AC power into DC power having a desired voltage level. For example, isolated AC-DC PFC rectifiers are used as chargers or front end converters in high frequency isolated Uninterruptible Power Supply (UPS) systems, in telecommunication systems for providing desired DC voltage (e.g., 48V) to a distribution bus, and in High Voltage Direct Current (HVDC) datacenter power supplies to provide desired DC voltage (e.g., 240V or 380V) to a distribution bus.

### SUMMARY OF INVENTION

At least one aspect of the invention is directed to a rectifier system comprising an input configured to be coupled to a power source and to receive input AC power, a first converter coupled to the input and configured to generate, at an output of the first converter, rectified AC power having a desired amplitude, the rectified AC power derived from the input AC power, a rectified AC bus coupled to the output of the first converter, a second converter coupled to the rectified AC bus and configured to receive the rectified AC power from the first converter via the rectified AC bus and convert the rectified AC power into regulated DC output power, an output coupled to the second converter and configured to provide the regulated DC output power to a load coupled to the output, and a first controller coupled to the first converter and configured to operate the first converter at a first frequency to generate the rectified AC power having the desired amplitude.

According to one embodiment, the rectifier system further comprises a capacitor coupled to the rectified AC bus. In one embodiment, the capacitor is a film type capacitor.

According to another embodiment, the rectifier system further comprises an input rectifier coupled between the input and the first converter and configured to rectify the input AC power, wherein the rectified AC power generated by the first converter is derived from rectified input AC power provided to the first converter by the input rectifier. In one embodiment, the rectifier system further comprises an input filter coupled between the input rectifier and the first converter.

According to one embodiment, the first converter is a resonant converter comprising a converter bridge coupled to the input, a resonant tank coupled to the converter bridge, and a rectifier coupled between the resonant tank and the rectified AC bus, wherein the first controller is configured to operate the converter bridge at the first frequency to generate the rectified AC power having the desired amplitude. In one embodiment, the resonant tank comprises an inductor coupled to the converter bridge, a capacitor coupled to the inductor, and a transformer having a primary winding coupled to the capacitor and a secondary winding coupled to the rectifier.

According to another embodiment, the rectifier system further comprises a second controller coupled to the second converter and configured to operate the second converter at a second operating frequency to generate the regulated DC output power. In one embodiment, the second converter is a boost converter. In another embodiment, the second controller controls the second converter to provide power factor correction on the input AC power. In another embodiment, the second converter comprises an inductor coupled to the rectified AC bus, at least one switch coupled to the inductor, a diode coupled to the switch, and a filter coupled between the diode and the output, wherein the second controller is configured to operate the at least one switch at the second frequency to generate the regulated DC output power.

According to one embodiment, the first converter is further configured to provide galvanic isolation between the input and the output.

Another aspect of the invention is directed to a method for providing regulated DC power to a load, the method comprising receiving input AC power, generating rectified AC power, the rectified AC power derived from the input AC power, converting the rectified AC power into regulated DC output power, and providing the regulated DC output power to an output coupled to the load.

According to one embodiment, generating the rectified AC power includes operating a first converter at a first frequency to generate the rectified AC power with a first amplitude. In one embodiment, generating the rectified AC power further includes operating the first converter at a second frequency to generate the rectified AC power with a second amplitude. In another embodiment, converting the rectified AC power into regulated DC output power includes operating a second converter at an operating frequency to generate the regulated DC output power. In one embodiment, the method further comprises filtering out a high frequency component from at least one of a current provided to the output from the second converter and a current provided to the first converter. In another embodiment, operating the second converter includes operating the second converter to provide power factor correction to the input AC power.

According to one embodiment, the method further comprises rectifying the input AC power, wherein generating rectified AC power includes generating rectified AC power derived from rectified input AC power.

At least one aspect of the invention is directed to a rectifier system comprising an input configured to be coupled to a power source and to receive input AC power, an output configured to be coupled to a load and to provide regulated DC output power to the load, and means for isolating the input from the output, for converting the input AC power into rectified AC power, and for converting the rectified AC power into the regulated DC output power.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a common isolated PFC rectifier system;

FIG. 2 is a block diagram of a PFC rectifier system according to at least one embodiment of the current invention;

FIG. 3 is a circuit diagram of a PFC rectifier system according to at least one embodiment of the current invention;

FIG. 4 provides a graph showing different waveforms related to the operation of a PFC rectifier system according to at least one embodiment of the current invention;

FIG. 5 is a block diagram of a multi-phase PFC rectifier system according to at least one embodiment of the current invention; and

FIG. 6 is a block diagram of a system upon which various embodiments of the current invention may be implemented.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

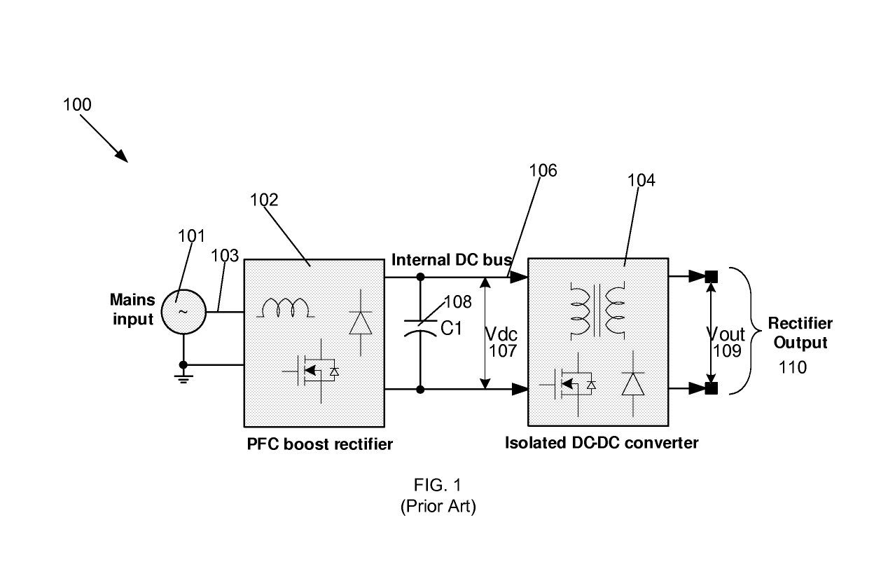

As discussed above, isolated AC-DC PFC rectifiers are commonly used in a variety of different applications. One common isolated PFC rectifier system 100 is shown below in FIG. 1. The PFC rectifier 100 includes a non-isolated front end PFC boost rectifier 102 coupled to an isolated DC-DC converter 104 via an internal DC bus 106. The non-isolated PFC boost rectifier 102 receives, at its input 103, AC power from a mains power source 101 and generates an intermediate high voltage DC voltage 107 (e.g., 400V) on the internal DC bus 106 across a bulk capacitor (C1) 108. The bulk capacitor (C1) is typically a relatively large electrolytic capacitor. The DC-DC converter 104 receives the intermediate high voltage DC voltage 107 and regulates the voltage 109 provided to the output 110 of the rectifier 100. The DC-DC converter 104 also provides isolation between the input and the output 110 of the rectifier 100.

The use of large bulk capacitors, such as electrolytic capacitors, in rectifier applications (e.g., as shown in the traditional rectifier 100 of FIG. 1) and in general power converters has potential drawbacks such as limited life, low reliability, low life expectancy, and increased size. Accordingly, an isolated and highly reliable PFC rectifier system is described herein that addresses the above issues related to the use of large bulk capacitors such as electrolytic capacitors.

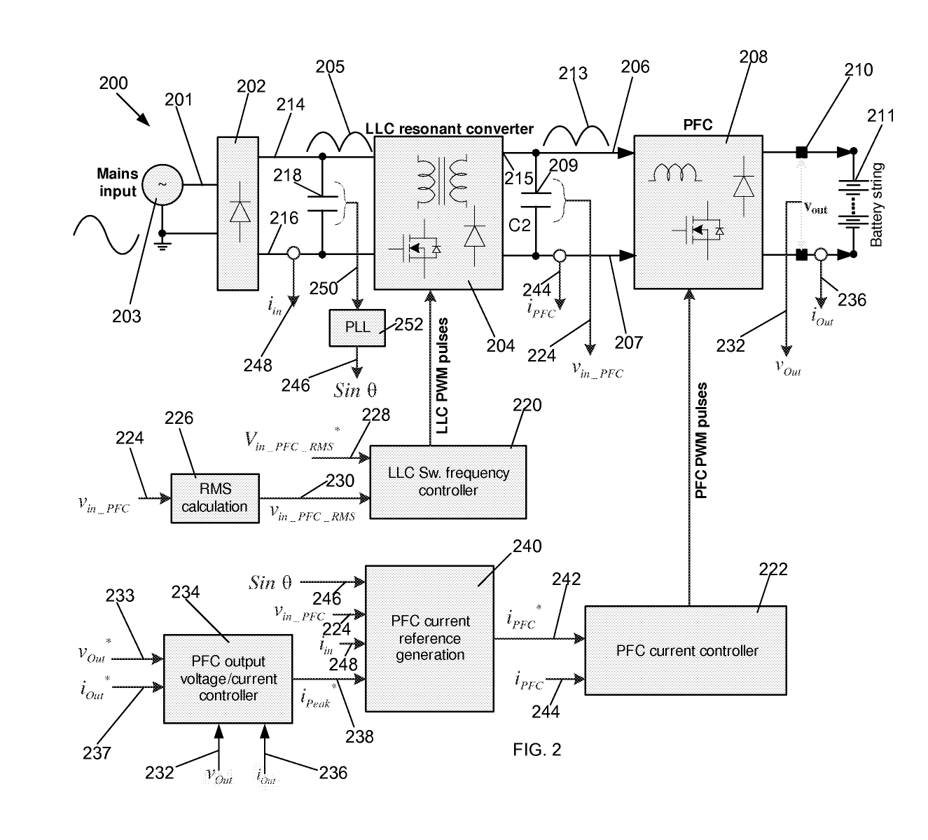

FIG. 2 is a block diagram of a PFC rectifier system 200 according to at least one embodiment of the current invention. The PFC rectifier system 200 includes an input 201, a rectifier 202, a resonant DC-DC converter 204, an internal rectified AC bus 206, a return bus 207, a PFC boost converter 208, and an output 210.

An input of the rectifier 202 is coupled to the input 201. An output of the rectifier 202 is coupled to the resonant DC-DC converter 204 via an input line 214 and a return line 216. A first capacitor 218 is coupled between the input line 214 and the return line 216. The internal rectified AC bus 206 and the return bus 207 are coupled between the resonant DC-DC converter 204 and the PFC boost converter 208. The internal rectified AC bus 206 is coupled to an output 215 of the resonant DC-DC converter 204. A second capacitor 209 is coupled between the internal rectified AC bus 206 and the return bus 207. The output 210 is coupled to an output of the PFC boost converter 208. The input 201 is configured to be coupled to an AC mains power source 203. The output 210 is configured to be coupled to a load 211. In one embodiment, the load 211 is a string of batteries. In other embodiments, the load 211 may be a single battery or another type of load.

The rectifier 202 receives AC power from the AC mains power source 203, via the input 201, rectifies the AC power, and provides rectified AC power 205 to the resonant converter 204 via the input line 214. The resonant DC-DC converter 204 converts the rectified AC voltage 205 to regulated rectified AC voltage 213 on the internal rectified AC bus 206 (i.e., across the second capacitor 209). According to one embodiment, the first and second capacitors 209, 218 are polypropylene capacitors; however, in other embodiments, different types of capacitors may be utilized. For example, in one embodiment, the first and/or second capacitors 209, 218 are film type capacitors with high ripple current handling capability.

The switching frequency of the resonant DC-DC converter 204 determines a level of the regulated rectified AC voltage 213 provided to the internal rectified AC bus 206. In one embodiment, the switching frequency of the resonant DC-DC converter 204 is controlled by a frequency controller 220. Operation of the frequency controller 220 is discussed in greater detail below. The resonant DC-DC converter may also provide galvanic isolation between the input 201 and the output 210 of the rectifier system 200.

According to one embodiment, the resonant DC-DC converter 204 is an LLC converter; however, in other embodiments, the converter 204 may be any other type of isolated or non-isolated resonant converter. Also, in other embodiments, the converter 204 may be any other type of isolated or non-isolated DC-DC converter.

The regulated rectified AC voltage 213 on the internal rectified AC bus 206 (and across the second capacitor 209) is provided to the PFC boost converter 208. The PFC boost converter 208 receives the regulated rectified AC voltage 213 from the internal rectified AC bus 206, converts the regulated rectified AC voltage 213 into DC power having desired DC voltage, and provides the DC power to the output 210. In one embodiment, the PFC boost converter 208 is controlled by a current controller 222. Operation of the current controller 222 is discussed in greater detail below. According to one embodiment, the PFC boost converter 208 is controlled such that the AC current at the input of the resonant converter 204 is in phase with mains input voltage.

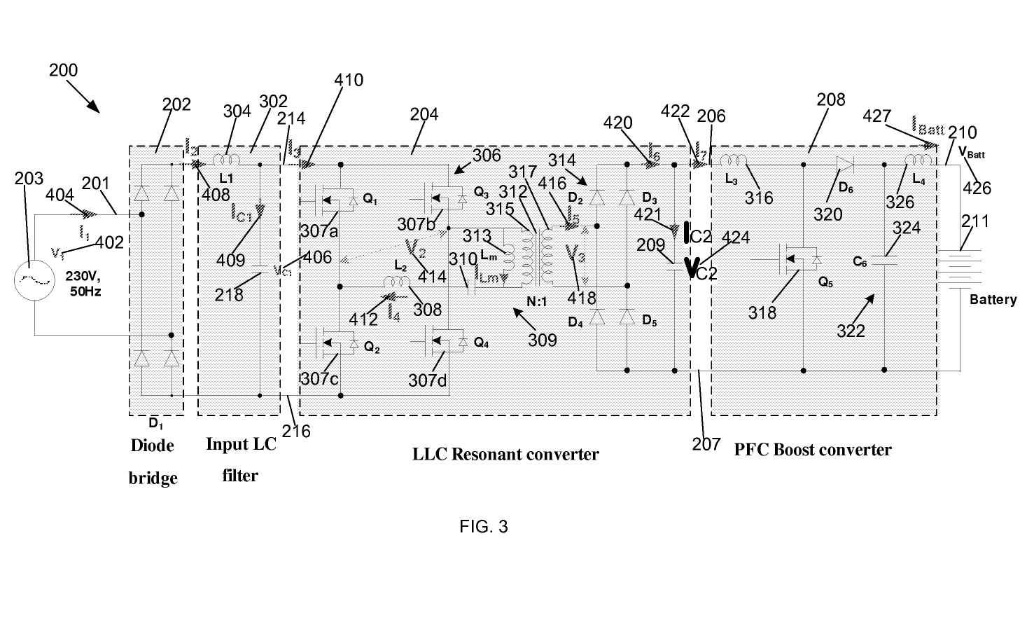

FIG. 3 is a more detailed circuit diagram of the PFC rectifier system 200 according to at least one embodiment of the current invention. The PFC rectifier system 200 includes the input 201, the rectifier 202, an input filter 302, the resonant DC-DC converter 204, the internal rectified AC bus 206, the return bus 207, the PFC boost converter 208, the return line 216, and the output 210. The input filter 302 includes a first inductor 304 and the first capacitor 218. The resonant DC-DC converter 204 includes a converter bridge 306, a resonant tank 309, a rectifier bridge 314, and the second capacitor 209. In one embodiment, the converter bridge 306 is a full-bridge converter including a plurality of switches (Q1-Q4) 307a-307d; however, in other embodiments, the converter bridge may be configured differently. In one embodiment, the switches (Q1-Q4) 307a-307d are Metal-Oxide-Semiconductor Field-Effect Transistors (MOSFET); however, in other embodiments, different types of switches and/or transistors may be utilized. In one embodiment, the resonant tank 309 includes a second inductor 308, a third capacitor 310, an inductor (Lₘ) 313, and a transformer 312; however, in other embodiments the resonant tank 309 may be configured differently. The PFC boost converter 208 includes a third inductor 316, a switch 318, a diode 320, and a high frequency filter 322. According to one embodiment, the high frequency filter 322 includes a fourth inductor 326 and a fourth capacitor 324; however, in other embodiments, the high frequency filter may be configured differently.

The input 201 of the system 200 is configured to be coupled to an AC source 203 (e.g., AC mains). An input of the rectifier 202 is coupled to the input 201. An output of the rectifier is coupled to a first terminal of the first inductor 304. A second terminal of the first inductor is coupled to the return line 216 via the first capacitor 218. The second terminal of the first inductor is also coupled to the drains of switch Q1 307a and switch Q3 307b. The source of switch Q1 307a is coupled to the drain of switch Q2 307c. The source of switch Q3 307b is coupled to the drain of switch Q4 307d. The sources of switch Q2 307c and switch Q4 307d are coupled to the return line 216. The source of switch Q3 307b is also coupled to a first end of a primary winding 315 of the transformer 312. A second end of the primary winding 315 of the transformer 312 is coupled to the source of switch Q1 307 (and the drain of switch Q2 307c) via the third capacitor 310 and the second inductor 308. The gate of each switch in the converter bridge 306 is coupled to the frequency controller 220.

The inductor (Lₘ) 313 represents the inductance seen across the transformer 312. In one embodiment, the inductor 313 is realized by introducing an air gap in the core of the transformer 312 (i.e., between the first winding and the second winding); however, in other embodiments, the inductor (Lₘ) 313 is realized using an additional inductor coupled across the first winding of the transformer 312.

A first end and a second end of a secondary winding 317 of the transformer 312 are coupled to the rectifier bridge 314. An output of the rectifier bridge 314 is coupled to a first terminal of the third inductor 316 via the internal rectified AC bus 206. The rectifier bridge 314 is also coupled to the boost converter 208 via the return bus 207. The second capacitor 209 is coupled between the internal rectified AC bus 206 and the return bus 207. A second terminal of the third inductor 316 is coupled to the anode of the diode 320. The drain of the switch 318 is also coupled to the anode of the diode 320. The source of the switch 318 is coupled to the return bus 207. The gate of the switch 318 is coupled to the current controller 222. The cathode of the diode 320 is coupled to a first terminal of the fourth inductor 326. The fourth capacitor 324 is coupled between the first terminal of the fourth inductor 326 and the return bus 207. A second terminal of the fourth inductor is coupled to the output 210 of the system 200. The output of the system 200 is configured to be coupled to at least one battery 211. According to one embodiment, the fourth inductor 326 is removed and replaced with a short.

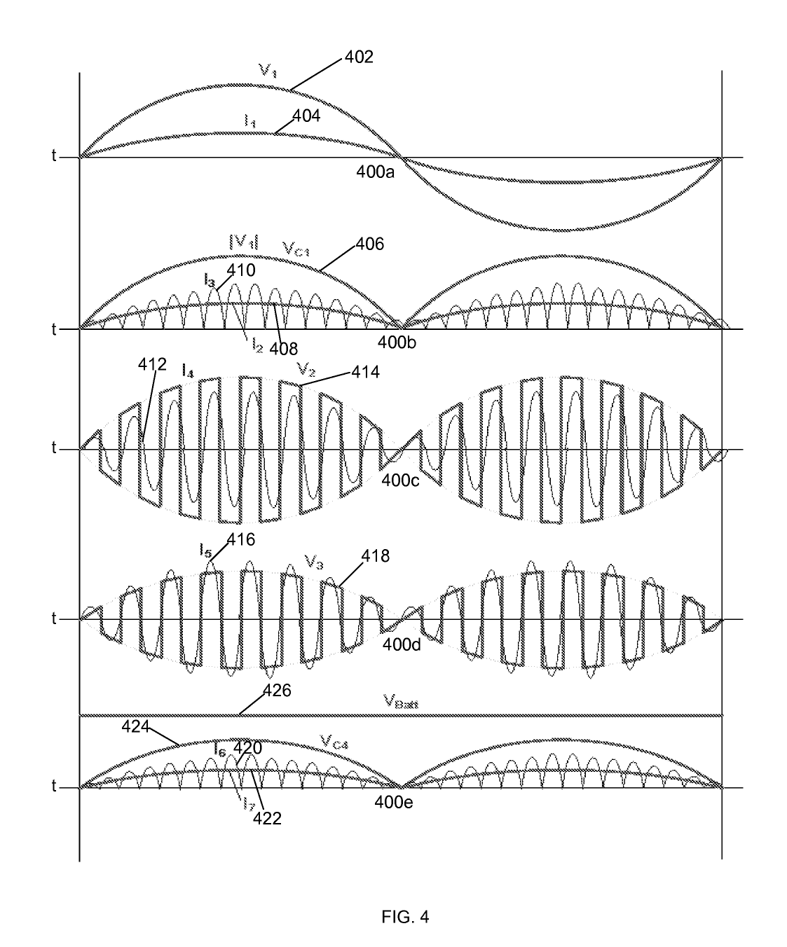

FIG. 4 provides a graph showing different waveforms 400(a-e) related to the operation of the PFC rectifier system 200. Waveform 400a illustrates input AC mains voltage (V1) 402 in relation to input current (I₁) 404 of the system 200. Waveform 400b illustrates current (I₂) 408 from the rectifier 202 into the input filter 302, current (I₃) 410 from the input filter 302 into the resonant converter 204, and voltage (V_{C1}) 406 across the first capacitor 218. Waveform 400c illustrates current (I₄) through the second inductor 308 and voltage (V₂) across the source of switch Q3 307b and switch Q1 307a. Waveform 400d illustrates current (I₅) from the second winding of the transformer 312 to the rectifier bridge 314 and voltage (V₃) across the second winding of the transformer 312. Waveform 400e illustrates current (I₆) 420 out of the rectifier bridge 314, current (I₇) 422 into the boost converter 208, voltage (V_{C2}) 424 across the second capacitor 209, and the voltage (V_{Batt}) across the battery 211. Operation of the PFC rectified system 200 is discussed in greater detail below with regard to FIGS. 3 and 4.

The rectifier 202 receives input AC mains voltage (V₁) 402 from the AC source 203 and rectifies the input AC mains voltage (V₁) 402. The rectified AC voltage (V_{C1}) 406 is provided to the resonant converter 204 via the input filter 302. The input current (I₃) 410 of the resonant converter 204 is rectified resonant current (I₄) 412. The input current (I₃) 410 contains low-frequency and high-frequency current components. The input filter 302 diverts the switching frequency component of current (I₃) 410 to the first capacitor 218 as current (I_{C1}) 409. The input filter 302 allows the low-frequency component of current (I₃) 410 to pass from the output of the rectifier 202 through the first inductor 304. According to one embodiment the first inductor 304 of the input filter 302 is a separate inductor; however, in other embodiments, the inductance of the first inductor 304 may be provided by another device such as a cable or an Electro-Magnetic Interference filter.

Upon receiving the rectified AC voltage (V_{C1}) 406, the converter bridge 306 is operated by the frequency controller 220 (e.g., by transmitting signals to the gates of the switches (Q1-Q4) 307a-307d) to generate the desired voltage V₂ 414. According to one embodiment, the frequency controller 220 operates the converter bridge 306 at a switching frequency (F_{SW}) with 50% duty cycle in a complementary Pulse Width Modulation (PWM) mode to generate the AC voltage V₂. However, in other embodiments, the frequency controller 220 may configure the switching frequency and PWM differently.

The AC voltage V₂ 414 is provided to the resonant tank 309. The resulting resonant current (I₄) 412 in the resonant tank 309 is a sine wave. According to one embodiment, the switches (Q1-Q4) 307a-307d of the converter bridge 306 are operated by the frequency controller 220 to implement soft-switching (i.e., Zero-Cross Switching (ZCS)). Also, as the amplitude of the voltage V₂ 414 varies sinusoidally, the amplitude of current I₄ 412 may have similar variation.

As the voltage V₂ 414 is provided to the transformer 312 of the resonant tank 309, the primary winding 315 of the transformer 312 is energized and corresponding voltage (V₃) 418 and current (I₅) 416 is generated in the secondary winding 317 of the transformer 312. According to one embodiment, the turns ratio of the transformer 312 is 1; however, in other embodiments, the turns ratio of the transformer 312 may be configured differently. The voltage V₃ 418 and current I₅ 416 are provided to the rectifier bridge 314. The resulting rectified current I₆ 420 is output by the rectifier bridge 314 and the rectified voltage V_{C2} 424 is generated across the second capacitor 209. The second capacitor 209 absorbs the high frequency current ripple (I_{C2}) 421 of current I₆ 420 and allows the low-frequency current component of current I₆ 420 to pass to the boost converter 208 as current I₇ 422. According to one embodiment, the value of the second capacitor 209 is relatively low. For example, in one embodiment, the second capacitor 209 has a capacitance of 1 μF-2.2 μF. However, in other embodiments, the second capacitor 209 may be configured differently.

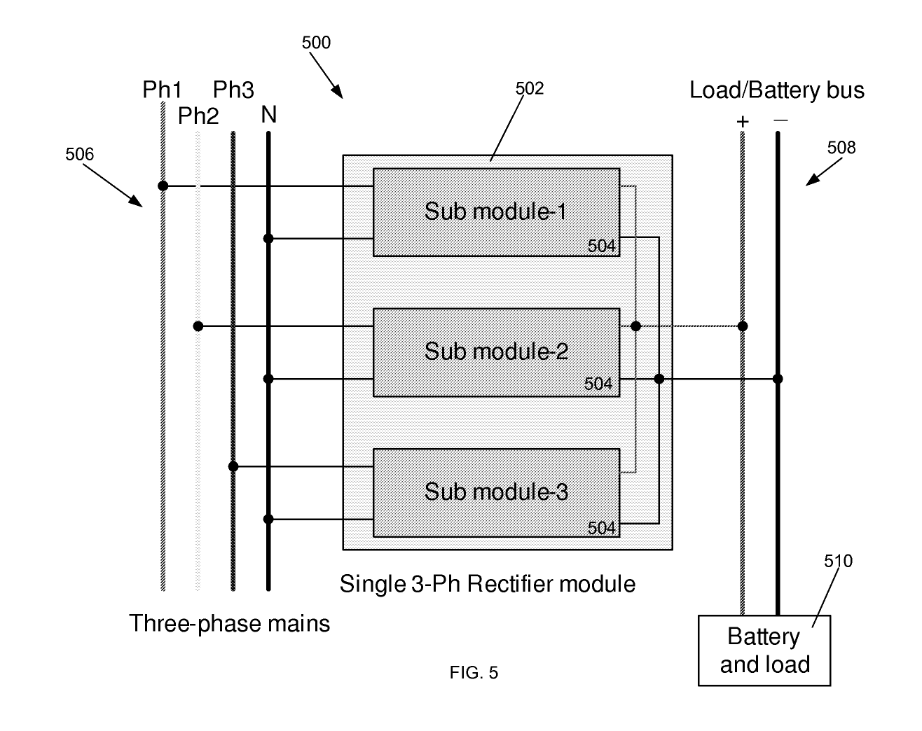

Due to its relatively low value, the second capacitor 209 allows the voltage across it (i.e., voltage V_{C2} 424) to vary in response to input voltage variation. For example, as shown in FIG. 5, the voltage V_{C2}424 is a scaled version of the rectified input voltage V_{C1} 406. The frequency controller 220 can regulate (i.e., increase or decrease to a desired level) the amplitude of the rectified sine wave voltage V_{C2} 424 across the second capacitor 209 by controlling (i.e., increasing or decreasing) the switching frequency (F_{SW}) of the resonant converter 204.

The PFC boost converter 208 is controlled by the current controller 222 such that the current I₇ 422 drawn from the resonant converter 204 is proportional to the rectified sine wave voltage V_{C2}424 across the second capacitor 209. Accordingly, the input to the PFC boost converter 208 can be realized as a virtual resistor, whose resistance value depends on the total output power of the system 200. The high frequency filter 322 at the output of the system 200 diverts the high frequency (i.e., the switching frequency) current components in the diode 320 to the fourth capacitor 324. According to one embodiment, the values of the fourth inductor 326 and the fourth capacitor 324 are low. For example, in one embodiment the fourth inductor 326 has an inductance of 10 μH-25 μH and the fourth capacitor 324 has a capacitance of 1 μF-2.2 μF. However, in other embodiments, the fourth inductor 326 and the fourth capacitor 324 may be configured differently. The DC and the second harmonic (i.e., low frequency) current components in the diode are passed to the output 210 of the system 200 as output current (I_{BATT}) 427. The PFC boost converter 208 may provide Power Factor Correction (PFC) of the system 200.

Control of the system 200 is discussed below with regard to FIG. 2. As discussed above, the frequency controller 220 operates the resonant converter 204 with 50% duty cycle PWM. The controller 220 monitors the output of the resonant converter 204. For example, in one embodiment, a signal (Vᵢₙ_{_}_{PFC}) 224 representing the output voltage of the converter 204 (i.e., the voltage V_{C2} 424) is passed to an RMS calculation module 226 which generates a signal (Vᵢₙ_{_}_{PFC}_{_}_{RMS}) 230 that represents the RMS output voltage of the converter 204. The frequency controller 220 calculates the difference between the calculated RMS output voltage of the converter and a reference RMS output voltage (Vᵢₙ_{_}_{PFC}_{_}_{RMS}*) 228. The difference between the calculated voltage and the reference RMS output voltage is processed through a Proportional-Integral (PI) controller within the controller 220. Based on the output of the PI controller, the frequency controller 220 sets the switching frequency of the resonant converter 204. In one embodiment, the frequency of the converter 204 is set at the resonant frequency at or about the nominal input voltage. The frequency of the converter 204 may be increased above or decreased below the resonant frequency during high line and low line conditions, respectively, to regulate the output voltage (V_{C2}) 424 of the converter 204.

As also discussed above, the current controller 222 operates the PFC boost converter 208. The controller 222 monitors the output of the PFC boost converter 208. For example, in one embodiment, a signal (v_{Out}) 232 representing the output voltage of the PFC boost converter 208 (i.e., the voltage V_{Batt} 426) and a signal (i_{Out}) 236 representing the output current of the PFC boost converter 208 (i.e., the current I_{Batt} 427) are passed to an output voltage/current module 234. In one embodiment, the output voltage/current module 234 is a PI controller; however, in other embodiments, the output voltage/current module 234 may be configured differently. The output voltage/current module 234 compares the output voltage of the PFC boost converter 208 with a reference output voltage (v_{Out}*) 233, compares the output current of the PFC boost converter 208 with a reference output current (i_{Out}*) 237, and based on the difference between the voltage and current signals, determines the output voltage/current error of the PFC boost converter 208. Based on the calculated voltage/current error, the output voltage/current module outputs a reference signal (i_{Peak}*) 238 that represents the peak amplitude of the input current of the PFC boost converter 208. The reference signal (i_{Peak}*) 238 is provided to a current reference generation module 240.

The current reference generation module 240 multiplies the signal (i_{Peak}*) 238 by the signal (Vᵢₙ_{_}_{PFC}) 224 representing the output voltage of the converter 204 to generate the reference signal (i_{PFC}*) 242 which represents a reference input current of the PFC boost converter 208. The current controller 222 calculates a PFC boost converter input current error based on the difference between the reference signal (i_{PFC}*) 242 and the signal (i_{PFC}) 244 which represents the calculated input current of the PFC boost converter 208. Based on the calculated input current error, the current controller 222 provides PWM pulses to the PFC boost converter 208 to regulate the PFC boost converter 208.

According to one embodiment, the current reference generation module 240 also receives signals Sin θ 246 and signal iᵢₙ 248. Signal Sin θ 246 is a mains voltage template which is in phase with mains voltage (V1) 402. In one embodiment, the signal Sin θ 246 is kept in phase with mains voltage (V1) 402 through the use of a Phase Locked Loop (PLL) 252. Signal iᵢₙ 248 represents the input current of the converter 204. The current reference generation module 240 may use signals Sin θ 246 and iᵢₙ 248 to modify the PFC input current reference signal (I_{PFC}*) 242 such that the mains current 404 has low Input current Total Harmonic Distortion (I_THD) and near unity Power Factor (PF). In such case, the PFC boost converter input current 422 can be allowed to have little low frequency distortion, as control of the mains current 404 may be a higher priority.

According to one embodiment, a plurality of the PFC rectifier systems 200 may be included within a larger rectifier system. For example, in one embodiment as shown in FIG. 5, a rectifier system 500 includes at least one rectifier module 502 that includes a plurality of rectifier sub-modules 504 (e.g., each sub-module being one of the PFC rectifier systems 200). Each sub-module 504 is fed input power from one phase 506 of a multi-phase mains power source (e.g., three-phase mains) and operates on the input power as discussed above. The output of each sub-module 504 are connected in parallel to an output of the rectifier module 502. The output of the rectifier module 505 is coupled to a load/battery bus 508 which is coupled to a load/battery. In such a three phase rectifier system 500, the sum of all second harmonic (i.e., low frequency) current components of the three sub-modules 504 is zero, so the battery 510 will not experience any low frequency current ripple.

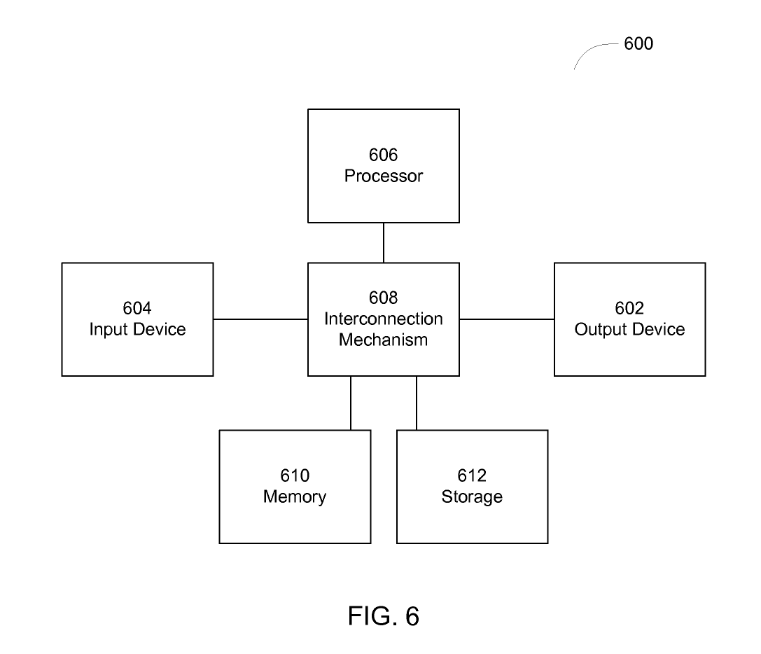

FIG. 6 illustrates an example block diagram of computing components forming a system 600 which may be configured to implement one or more aspects disclosed herein. For example, the system 600 may be communicatively coupled to a rectifier system and configured to operate the rectifier system as described above and perform the controller functions in the embodiments described above.

The system 600 may include for example a general-purpose computing platform such as those based on Intel PENTIUM-type processor, Motorola PowerPC, Sun UltraSPARC, Texas Instruments-DSP, Hewlett-Packard PA-RISC processors, or any other type of processor. System 600 may include specially-programmed, special-purpose hardware, for example, an application-specific integrated circuit (ASIC). Various aspects of the present disclosure may be implemented as specialized software executing on the system 600 such as that shown in FIG. 6.

The system 600 may include a processor/ASIC 606 connected to one or more memory devices 610, such as a disk drive, memory, flash memory or other device for storing data. Memory 610 may be used for storing programs and data during operation of the system 600. Components of the computer system 600 may be coupled by an interconnection mechanism 608, which may include one or more buses (e.g., between components that are integrated within a same machine) and/or a network (e.g., between components that reside on separate machines). The interconnection mechanism 608 enables communications (e.g., data, instructions) to be exchanged between components of the system 600.

The system 600 also includes one or more input devices 604, which may include for example, a keyboard or a touch screen. The system 600 includes one or more output devices 602, which may include for example a display. In addition, the computer system 600 may contain one or more interfaces (not shown) that may connect the computer system 600 to a communication network, in addition or as an alternative to the interconnection mechanism 608.

The system 600 may include a storage system 612, which may include a computer readable and/or writeable nonvolatile medium in which signals may be stored to provide a program to be executed by the processor or to provide information stored on or in the medium to be processed by the program. The medium may, for example, be a disk or flash memory and in some examples may include RAM or other non-volatile memory such as EEPROM. In some embodiments, the processor may cause data to be read from the nonvolatile medium into another memory 610 that allows for faster access to the information by the processor/ASIC than does the medium. This memory 610 may be a volatile, random access memory such as a dynamic random access memory (DRAM) or static memory (SRAM). It may be located in storage system 612 or in memory system 610. The processor 606 may manipulate the data within the integrated circuit memory 610 and then copy the data to the storage 612 after processing is completed. A variety of mechanisms are known for managing data movement between storage 612 and the integrated circuit memory element 610, and the disclosure is not limited thereto. The disclosure is not limited to a particular memory system 610 or a storage system 612.

The system 600 may include a general-purpose computer platform that is programmable using a high-level computer programming language. The system 600 may be also implemented using specially programmed, special purpose hardware, e.g. an ASIC. The system 600 may include a processor 606, which may be a commercially available processor such as the well-known Pentium class processor available from the Intel Corporation. Many other processors are available. The processor 606 may execute an operating system which may be, for example, a Windows operating system available from the Microsoft Corporation, MAC OS System X available from Apple Computer, the Solaris Operating System available from Sun Microsystems, or UNIX and/or LINUX available from various sources. Many other operating systems may be used.

The processor and operating system together may form a computer platform for which application programs in high-level programming languages may be written. It should be understood that the disclosure is not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

As described above, the resonant converter 204 is utilized with a boost converter 208; however, in other embodiments, the resonant converter 204 may be utilized with other types of converters to regulate the system.

As also described above, multiple controllers are utilized to operate the system; however, in other embodiments, a single controller may be configured to operate the entire system.

As described above, the input filter 302 is coupled between the rectifier 202 and the converter 204; however, in other embodiments the input filter 302 is coupled between the input 201 and the rectifier 202.

As described above, the resonant converter 204 is a full-bridge converter; however, in other embodiments, the converter 204 may be a half-bridge converter or some other type of converter.

As described above, the converter 208 includes a single switch 318; however, in other embodiments, the converter 208 may include any number of switches.

Such a system as described above may be utilized in a UPS, in a HVDC Datacenter, in a telecommunication system, or in any other type of system utilizing rectification.

As described herein, an isolated and highly reliable PFC rectifier system is provided that addresses the above issues related to the use of large bulk capacitors such as electrolytic capacitors. By utilizing an internal rectified AC bus rather than an internal DC bus, the need for large bulk capacitors, such as electrolytic capacitors, may be eliminated.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A rectifier system comprising:
an input configured to be coupled to a power source and to receive input AC power;
a first converter coupled to the input and configured to generate, at an output of the first converter, rectified AC power having a desired amplitude, the rectified AC power derived from the input AC power;
a rectified AC bus coupled to the output of the first converter;
a second converter coupled to the rectified AC bus and configured to receive the rectified AC power from the first converter via the rectified AC bus and convert the rectified AC power into regulated DC output power;
an output coupled to the second converter and configured to provide the regulated DC output power to a load coupled to the output; and
a first controller coupled to the first converter and configured to operate the first converter at a first frequency to generate the rectified AC power having the desired amplitude.

2. The rectifier system of claim 1, further comprising a capacitor coupled to the rectified AC bus.

3. The rectifier system of claim 2, wherein the capacitor is a film type capacitor.

4. The rectifier system of claim 1, further comprising an input rectifier coupled between the input and the first converter and configured to rectify the input AC power, wherein the rectified AC power generated by the first converter is derived from rectified input AC power provided to the first converter by the input rectifier.

5. The rectifier system of claim 1, further comprising an input filter coupled between the input rectifier and the first converter.

6. The rectifier system of claim 1, wherein the first converter is a resonant converter comprising:
a converter bridge coupled to the input;
a resonant tank coupled to the converter bridge; and
a rectifier coupled between the resonant tank and the rectified AC bus;
wherein the first controller is configured to operate the converter bridge at the first frequency to generate the rectified AC power having the desired amplitude.

7. The rectifier system of claim 6, wherein the resonant tank comprises:
an inductor coupled to the converter bridge;
a capacitor coupled to the inductor; and
a transformer having a primary winding coupled to the capacitor and a secondary winding coupled to the rectifier.

8. The rectifier system of claim 1, further comprising a second controller coupled to the second converter and configured to operate the second converter at a second operating frequency to generate the regulated DC output power.

9. The rectifier system of claim 8, wherein the second converter is a boost converter.

10. The rectifier system of claim 8, wherein the second controller controls the second converter to provide power factor correction on the input AC power.

11. The rectifier system of claim 8, wherein the second converter comprises:
an inductor coupled to the rectified AC bus;
at least one switch coupled to the inductor;
a diode coupled to the switch; and
a filter coupled between the diode and the output,
wherein the second controller is configured to operate the at least one switch at the second frequency to generate the regulated DC output power.

12. The rectifier system of claim 1, wherein the first converter is further configured to provide galvanic isolation between the input and the output.

13. A method for providing regulated DC power to a load, the method comprising:
receiving input AC power;
generating rectified AC power, the rectified AC power derived from the input AC power;
converting the rectified AC power into regulated DC output power; and
providing the regulated DC output power to an output coupled to the load.

14. The method of claim 13, wherein generating the rectified AC power includes operating a first converter at a first frequency to generate the rectified AC power with a first amplitude.

15. The method of claim 14, wherein generating the rectified AC power further includes operating the first converter at a second frequency to generate the rectified AC power with a second amplitude.

16. The method of claim 13, wherein converting the rectified AC power into regulated DC output power includes operating a second converter at an operating frequency to generate the regulated DC output power.

17. The method of claim 16, further comprising filtering out a high frequency component from at least one of a current provided to the output from the second converter and a current provided to the first converter.

18. The method of claim 16, wherein operating the second converter includes operating the second converter to provide power factor correction to the input AC power.

19. The method of claim 13, further comprising rectifying the input AC power, wherein generating rectified AC power includes generating rectified AC power derived from rectified input AC power.

20. A rectifier system comprising:
an input configured to be coupled to a power source and to receive input AC power;
an output configured to be coupled to a load and to provide regulated DC output power to the load; and
means for isolating the input from the output, for converting the input AC power into rectified AC power, and for converting the rectified AC power into the regulated DC output power.
